(19) United States
(12) Patent Application Publication
(10) Pub. No.: US 2024/0207958 A1
(43) Pub. Date: Jun. 27, 2024

(54) WIRE ELECTRICAL DISCHARGE MACHINING APPARATUS AND WIRE ELECTRICAL DISCHARGE MACHINING METHOD

(71) Applicant: Mitsubishi Electric Corporation, Tokyo (JP)

(72) Inventor: Hidetaka MIYAKE, Tokyo (JP)

(73) Assignee: Mitsubishi Electric Corporation, Tokyo (JP)

(21) Appl. No.: 18/288,384

(22) PCT Filed: May 7, 2021
(86) PCT No.: PCT/JP2021/017521

§ 371 Date: Oct. 26, 2023

(51) Int. Cl. B23H 1/10; B23H 7/10

(52) U.S. Cl. CPC B23H 1/10; B23H 7/101

(57) ABSTRACT

A control unit controls a holding device so that a cutting feed stage is driven when cutting is started to move upward a workpiece fixing plate on which a workpiece is placed and fixed and a pair of machining fluid flow straightening plates relative to a pair of machining fluid escape prevention plates so as to bring the workpiece fixing plate and the pair of machining fluid flow straightening plates closer to a plurality of cutting wire portions, and a workpiece retainer is held in an initial cutting position until the workpiece reaches a first position by the upward movement, and controls the holding device to release the hold of the workpiece retainer after the workpiece reaches the first position.

### FIELD

The present disclosure relates to a wire electrical discharge machining apparatus and a wire electrical discharge machining method for performing electrical discharge machining to cut a plurality of plate-shaped members from a workpiece all at once, using a wire electrode.

### BACKGROUND

A multi-wire electrical discharge machining apparatus generates electrical discharges between a plurality of wire electrodes and a workpiece to cut a plurality of plate-shaped members from the workpiece all at once. The multi-wire electrical discharge machining apparatus is used, for example, for slicing to cut a plurality of wafers from an ingot in a semiconductor manufacturing process. During the formation of thin plates that are machined all at once, the thin plates are shaken by the flow of a machining fluid supplied between the electrodes, thereby causing conditions where the space between adjacent thin plates is narrowed. As a result, a discharge failure of cut debris or a cooling failure of a wire electrode destabilizes the electrical discharge machining.

Patent Literature 1 provides a retainer plate that presses and supports a workpiece from a top thereof to prevent the flutter of wafers due to the vibration of the workpiece caused by wire travel and external forces during cutting. Force to hold the retainer plate down is acquired using a weight part or a drive device such as a motor.

### CITATION LIST

### Patent Literature

Patent Literature 1: Japanese Patent Application Laid-open No. 2002-205255

### SUMMARY OF INVENTION

### Problem to be Solved by the Invention

In a method using a weight part in Patent Literature 1, the weight of the weight part becomes a load on a stage on which a workpiece is placed, and when a plurality of workpieces are placed on one and the same stage and machined, the weight of the weight part increases, thereby becoming necessary to reinforce a stage mechanism, such as to prevent deformation of a table used therefor and to increase driving force. Furthermore, in Patent Literature 1, the retainer plate holds a workpiece down from the start of machining to the end of machining. Therefore, in a method using a drive device such as a motor, in order to prevent interference between the wire electrodes and the retainer plate, it is necessary to drive and move the retainer plate from the start of machining to the end of machining while applying a load to the workpiece with the retainer plate, thereby causing a problem of complicated control.

The present disclosure has been made in view of the above circumstances, and it is an object of the present disclosure to provide a wire electrical discharge machining apparatus that eliminates the need for reinforcement of a stage mechanism and achieves wire electrical discharge machining under simpler control.

### Means to Solve the Problem

In order to solve the above-mentioned problems and achieve the object, the present disclosure provides a wire electrical discharge machining apparatus, comprising: a wire electrode including two or more cutting wire portions that are spaced apart from each other in parallel to each other and face a workpiece; a power feeding unit to generate electrical discharges between the cutting wire portions and the workpiece; a pair of nozzles including two or more ejection orifices through which the cutting wire portions are inserted, to supply a machining fluid to gaps between the cutting wire portions and the workpiece; a workpiece fixing plate on which the workpiece is placed and fixed; a pair of machining fluid flow straightening plates provided on both sides of the workpiece to sandwich the workpiece; a pair of machining fluid escape prevention plates which are provided to sandwich the workpiece fixing plate and the pair of machining fluid flow straightening plates and connected to the ejection orifices of the pair of nozzles, and include two or more through holes through which the cutting wire portions are inserted; a workpiece retainer inserted from above the workpiece and the cutting wire portions into a space surrounded by the pair of machining fluid flow straightening plates and the pair of machining fluid escape prevention plates, to hold the workpiece being separated during cutting; a cutting feed stage to move the workpiece fixing plate and the pair of machining fluid flow straightening plates up and down with respect to the pair of machining fluid escape prevention plates and the cutting wire portions; a holding device to hold the workpiece retainer in an initial cutting position upwardly away from the cutting wire portions; and a control unit to control the holding device so that the cutting feed stage is driven when cutting is started to move upward the workpiece fixing plate on which the workpiece is placed and fixed and the pair of machining fluid flow straightening plates with respect to the pair of machining fluid escape prevention plates so as to bring the workpiece fixing plate and the pair of machining fluid flow straightening plates closer to the cutting wire portions, and the workpiece retainer is held in the initial cutting position until the workpiece reaches a first position by the upward movement, and to control the holding device to release the hold of the workpiece retainer after the workpiece reaches the first position.

### Effects of the Invention

The wire electrical discharge machining apparatus according to the present disclosure has an advantageous effect of being able to eliminate the need for reinforcement of a stage mechanism and achieve wire electrical discharge machining under simpler control.

### BRIEF DESCRIPTION OF DRAWINGS

FIG. 1 is a conceptual diagram illustrating a configuration example of a wire electrical discharge machining apparatus according to a first embodiment.

FIG. 2 is an exploded perspective view illustrating a configuration example of a machining fluid flow path restriction unit of the wire electrical discharge machining apparatus according to the first embodiment.

FIG. 3 is a perspective view illustrating a structure of a workpiece retainer included in the wire electrical discharge machining apparatus according to the first embodiment.

FIG. 4 is a cross-sectional view illustrating a structure of the machining fluid flow path restriction unit included in the wire electrical discharge machining apparatus according to the first embodiment.

FIG. 5 is another cross-sectional view illustrating the structure of the machining fluid flow path restriction unit included in the wire electrical discharge machining apparatus according to the first embodiment.

FIG. 6 is a block diagram illustrating a configuration example of a control unit included in the wire electrical discharge machining apparatus according to the first embodiment.

FIG. 7 is a flowchart illustrating the operation of the wire electrical discharge machining apparatus according to the first embodiment at the time of cutting.

FIG. 8 is a cross-sectional view illustrating the movement of the wire electrical discharge machining apparatus according to the first embodiment in a first stage during cutting.

FIG. 9 is a cross-sectional view illustrating the movement of the wire electrical discharge machining apparatus according to the first embodiment in a second stage during cutting.

FIG. 10 is a cross-sectional view illustrating the movement of the wire electrical discharge machining apparatus according to the first embodiment in a third stage during cutting.

FIG. 11 is an exploded perspective view illustrating a configuration example of a machining fluid flow path restriction unit of a wire electrical discharge machining apparatus according to a second embodiment.

FIG. 12 is a block diagram illustrating an example of a hardware configuration of the control unit included in the wire electrical discharge machining apparatus according to the first or second embodiment.

### DESCRIPTION OF EMBODIMENTS

Hereinafter, a wire electrical discharge machining apparatus and a wire electrical discharge machining method according to embodiments will be described in detail with reference to the drawings.

### First Embodiment

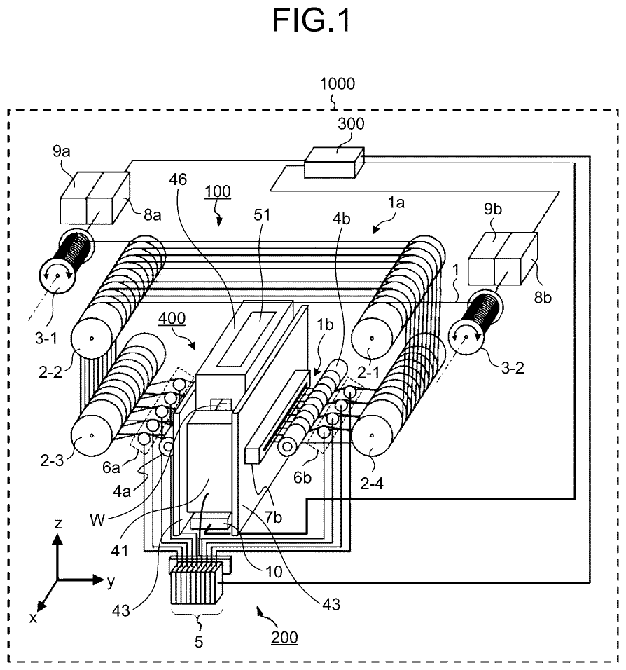

FIG. 1 is a conceptual diagram illustrating a configuration example of a wire electrical discharge machining apparatus 1000 according to a first embodiment. In FIG. 1, there are shown an x-axis, a y-axis, and a z-axis of a three-axis rectangular coordinate system. The y-axis corresponds to a travel direction of a wire electrode 1 above a workpiece W, the z-axis corresponds to the height direction (up and down direction), and the x-axis corresponds to a direction in which multiple portions of the wire electrode 1 are arranged in parallel above the workpiece W.

The wire electrical discharge machining apparatus 1000 includes a machining mechanism 100 for cutting the workpiece W with the wire electrode 1, a power feeding unit 200 for performing electric power feeding, a control unit 300, and a machining fluid flow path restriction unit 400. The wire electrical discharge machining apparatus 1000 cuts out a plurality of plate-shaped members from the workpiece W all at once. Examples of the workpiece W include tungsten, molybdenum, silicon carbide, single-crystal silicon, single-crystal silicon carbide, gallium nitride, and polycrystalline silicon.

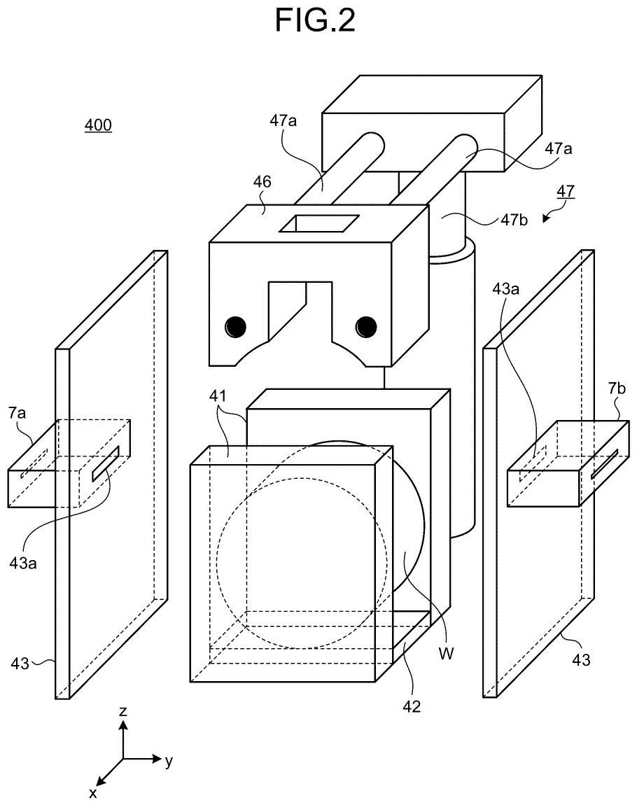

The machining mechanism 100 includes a plurality of guide rollers 2, bobbins 3, vibration-damping guide rollers 4a and 4b, nozzles 7a and 7b (see FIG. 2), bobbin rotation control devices 8a and 8b, traverse control devices 9a and 9b, and a cutting feed stage 10. The plurality of guide rollers 2 include a guide roller 2-1, a guide roller 2-2, a guide roller 2-3, and a guide roller 2-4. The bobbins 3 include a bobbin 3-1 and a bobbin 3-2.

The plurality of guide rollers 2 guide the travel of the wire electrode 1. The guide rollers 2-1, 2-2, 2-3, and 2-4 are installed rotatably about their respective rotation axes. The guide rollers 2-1, 2-2, 2-3, and 2-4 are spaced apart from each other and disposed in such a manner that their rotation axes are parallel to each other. The guide rollers 2-1, 2-2, 2-3, and 2-4, whose rotation axes are parallel to each other, allow the wire electrode 1 to travel with high accuracy. The rotation axes of the guide rollers 2-1, 2-2, 2-3, and 2-4 are disposed parallel to the x-axis.

The wire electrode 1 that is a single line is wound multiple times around the guide rollers 2-1, 2-2, 2-3, and 2-4 at intervals in the direction of the rotation axes of the guide rollers 2-1, 2-2, 2-3, and 2-4. These portions of the wire electrode 1 are collectively referred to as parallel wire portions 1a. Of the parallel wire portions 1a, portions facing the workpiece W are referred to as cutting wire portions 1b. The cutting wire portions 1b are formed by a plurality of portions of the wire electrode 1 arranged in parallel. The cutting wire portions 1b are desirably installed parallel to each other. On each of the surfaces of the guide rollers 2-1, 2-2, 2-3, and 2-4, multiple guide grooves are formed at equal intervals. By the wire electrode 1 being wound along the guide grooves, the guide rollers 2-1, 2-2, 2-3, and 2-4 keep the intervals between the portions of the wire electrode 1 constant. If the cutting wire portions 1b are disposed parallel to each other and at equal intervals, a plurality of plate-shaped members cut out can be equal in plate thickness and their parallel cross sections can be parallel with each other. The number of the guide rollers 2 does not necessarily need to be four, and may be three or less, or five or more.

The bobbins 3-1 and 3-2 cause the wire electrode 1 to travel by a feeding movement and a winding movement. The bobbin 3-1 performs the feeding movement, and the bobbin 3-2 performs the winding movement. The bobbin rotation control device 8a and the traverse control device 9a control the bobbin 3-1. The bobbin rotation control device 8b and the traverse control device 9b control the bobbin 3-2. The bobbin rotation control devices 8a and 8b control the rotation of the bobbin 3-1 and the rotation of the bobbin 3-2, respectively, to control the travel of the wire electrode 1. The bobbin rotation control devices 8a and 8b control, for example, the travel direction and the travel speed of the wire electrode 1.

The traverse control device 9a controls the position of the bobbin 3-1 in the x-axis direction according to the feeding position of the wire electrode 1. The traverse control device 9b controls the position of the bobbin 3-2 in the x-axis direction according to the winding position of the wire electrode 1. The position control of the bobbins 3-1 and 3-2 by the traverse control devices 9a and 9b is referred to as traverse control. Under the traverse control, the bobbins 3-1 and 3-2 can cause the wire electrode 1 to travel stably and highly accurately.

The wire electrode 1 fed from the bobbin 3-1 is wound on the guide roller 2-2, the guide roller 2-1, the guide roller 2-4, and the guide roller 2-3 in this order, and again wound from the guide roller 2-2 continuously. In this manner, the wire electrode 1 goes around the guide rollers 2-1, 2-2, 2-3, and 2-4 multiple times before being wound onto the bobbin 3-2.

The workpiece W is fixed on the inside of the machining fluid flow path restriction unit 400. The machining fluid flow path restriction unit 400 will be described in detail later. The machining fluid flow path restriction unit 400 in which the workpiece W has been fixed inside is installed between the vibration-damping guide roller 4a and the vibration-damping guide roller 4b. The vibration-damping guide rollers 4a and 4b restrict the movement of the wire electrode 1 in the z-axis direction, thereby dampening the vibration of the wire electrode 1 in the cutting wire portions 1b. Although the portions of the parallel wire portions 1a facing the workpiece W are referred to as the cutting wire portions 1b as described above, portions of the parallel wire portions 1a situated between the vibration-damping guide roller 4a and the vibration-damping guide roller 4b are also referred to as the cutting wire portions 1b. The vibration-damping guide roller 4a and the vibration-damping guide roller 4b may be omitted.

The nozzle 7a is disposed between the vibration-damping guide roller 4a and the machining fluid flow path restriction unit 400 (see FIG. 2). The nozzle 7b is disposed between the vibration-damping guide roller 4b and the machining fluid flow path restriction unit 400. The insides of the nozzles 7a and 7b are filled with a machining fluid. The nozzles 7a and 7b each include a plurality of ejection orifices (not illustrated) to eject the machining fluid with which their insides are filled, toward the workpiece W in the machining fluid flow path restriction unit 400. The parallel wire portions 1a are inserted through the ejection orifices of the nozzles 7a and 7b.

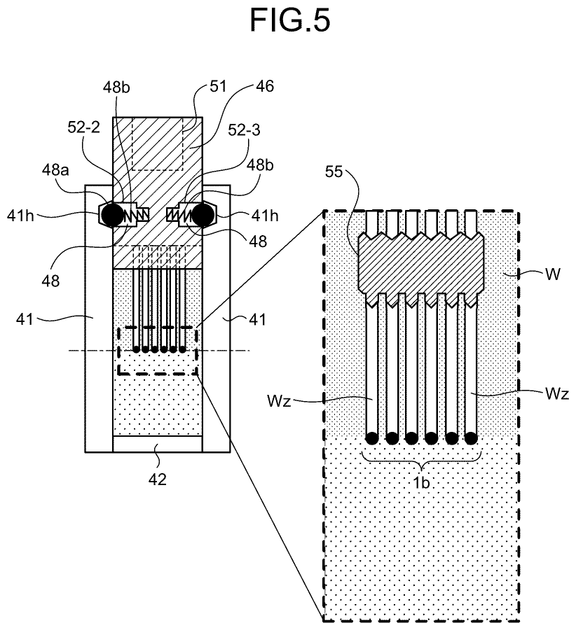

The cutting feed stage 10 changes the relative position between the workpiece W and the cutting wire portions 1b. In the first embodiment, the position of the cutting wire portions 1b in the z-axis direction is fixed, and the cutting feed stage 10 is movable in the z-axis direction. Specifically, the cutting feed stage 10 moves components inside the machining fluid flow path restriction unit 400 together with the workpiece W up and down with respect to a pair of machining fluid escape prevention plates 43, as described later in detail. By the up or down movement of the cutting feed stage 10, the workpiece W is relatively moved toward or away from the cutting wire portions 1b to cut the workpiece W. By electrical discharge machining on the workpiece W, machined grooves Wz (see FIG. 5) are formed in the workpiece W along the cutting wire portions 1b. The cutting feed stage 10 may be movable in the x-axis direction, the y-axis direction, and the z-axis direction.

The machining mechanism 100 may include a guide pulley that dampens the vibration of the wire electrode 1, a load cell that measures the tension of the wire electrode 1, a dancer roller that controls the tension of the wire electrode 1, etc. By using the load cell and the dancer roller, the tension of the wire electrode 1 may be maintained in a range suitable for the travel of the wire electrode 1. For example, by the dancer roller, the feeding speed and the winding speed of the wire electrode 1 may be changed to control the tension of the wire electrode 1.

The power feeding unit 200 includes a machining power supply 5 and power feed terminal units 6a and 6b. The machining power supply 5 supplies electric power to the wire electrode 1 via the feed terminal units 6a and 6b.

FIG. 2 is an exploded perspective view illustrating a configuration example of the machining fluid flow path restriction unit 400 of the wire electrical discharge machining apparatus 1000 according to the first embodiment. The machining fluid flow path restriction unit 400 includes a pair of machining fluid flow straightening plates 41, the pair of machining fluid escape prevention plates 43, a workpiece retainer 46, and a workpiece fixing plate 42. The machining fluid escape prevention plates 43 constitute a first member across which the cutting wire portions 1b are extended. The machining fluid flow straightening plates 41 and the workpiece fixing plate 42 constitute a second member on which the workpiece W is fixed and which forms, together with the first member, a space in which the machining fluid is flowed to the workpiece W from the first member. The workpiece retainer 46 constitutes a third member that is held in an initial cutting position upwardly away from the cutting wire portions 1b, and holds, from above, the workpiece W that is inserted into the space and separated during cutting.

The workpiece W is placed and fixed on the workpiece fixing plate 42. The workpiece W is fixed on the workpiece fixing plate 42 by a jig (not illustrated) for fixing the workpiece W placed on the cutting feed stage 10. The workpiece W is fixed on the workpiece fixing plate 42 with end faces of the workpiece W being sandwiched between and in close contact with the pair of machining fluid flow straightening plates 41. The pair of machining fluid flow straightening plates 41 are disposed parallel to the travel direction of the cutting wire portions 1b, to straighten the flow of the machining fluid.

In the machining fluid flow path restriction unit 400, in accordance with up-and-down movement of the cutting feed stage 10, the workpiece fixing plate 42 and the pair of machining fluid flow straightening plates 41 move up and down with respect to the pair of machining fluid escape prevention plates 43.

The pair of machining fluid escape prevention plates 43 are brought into close contact with end faces of the workpiece fixing plate 42 and the pair of machining fluid flow straightening plates 41, and are disposed on both sides of the workpiece W sandwiched between the machining fluid flow straightening plates 41. The pair of machining fluid escape prevention plates 43 are fixedly disposed without moving up and down.

The machining fluid escape prevention plates 43 are connected to the nozzles 7a and 7b. A plurality of through holes 43a for ejecting the machining fluid and allowing passage of the cutting wire portions 1b traveling in parallel are formed in portions of the machining fluid escape prevention plates 43 in contact with the ejection orifices of the nozzles 7a and 7b. The ejection orifices of the nozzles 7a and 7b and the through holes 43a of the machining fluid escape prevention plates 43 have the same dimensions. In FIG. 2, the through holes 43a of the machining fluid escape prevention plates 43 are illustrated as rectangular parallelepiped openings for convenience. The machining fluid escape prevention plates 43 are also in close contact with the workpiece retainer 46.

A position of the workpiece retainer 46 in the height direction is held by a workpiece retainer holding device 47. At the start of a cutting process, the workpiece retainer 46 is held in the initial cutting position upwardly away from the workpiece W and the cutting wire portions 1b. After the start of the cutting, the workpiece retainer 46 fixes thin plates being machined from the workpiece W into thin-plate shape forms.

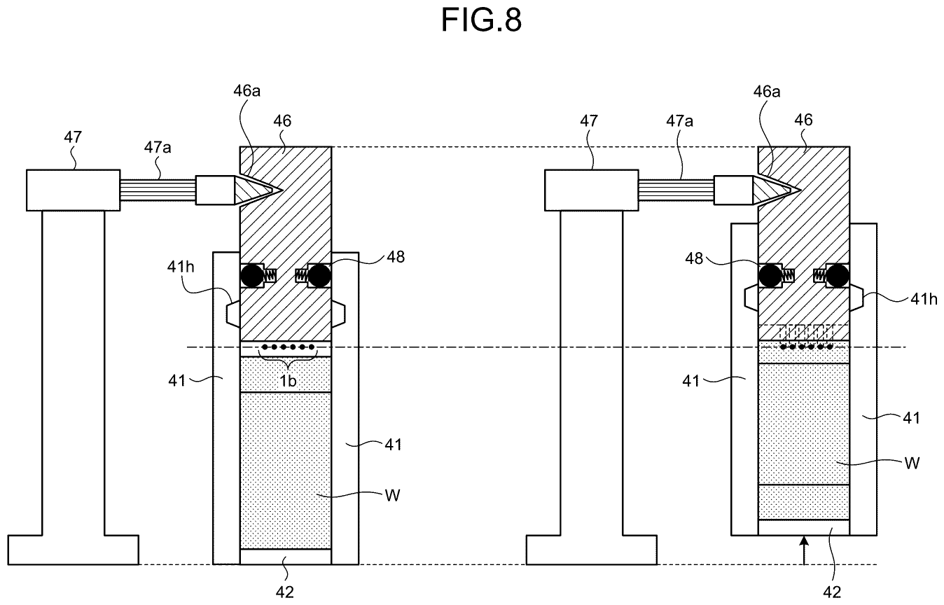

The workpiece retainer holding device 47 includes arm-shaped holding mechanisms 47a and supports the workpiece retainer 46 by the holding mechanisms 47a. Fitting portions 46a into which the distal ends of the holding mechanisms 47a are fitted are formed in the workpiece retainer 46 (see FIG. 8). The holding mechanisms 47a perform a retraction movement in the x-axis direction. The workpiece retainer holding device 47 includes an up and down movement mechanism 47b that moves the holding mechanisms 47a in the up and down directions. For example, the holding mechanisms 47a each include an air cylinder and a motor. The workpiece retainer holding device 47 is installed in a place where its position relative to the cutting wire portions 1b does not change, such as on a surface plate of the wire electrical discharge machining apparatus 1000.

The machining fluid is supplied from the nozzles 7a and 7b toward the workpiece W through the machining fluid escape prevention plates 43. It is desirable that machining fluid ejection holes in the machining fluid escape prevention plates 43 be disposed in a height position where the machining fluid ejection holes are closest to a portion of the workpiece W having the maximum cutting length, so as to facilitate the entry of the machining fluid into gaps between the cutting wire portions 1b and the workpiece W. In the case where the workpiece W has a cylindrical shape that changes in cutting thickness depending on a cutting position, the portion of the workpiece W having the maximum cutting length refers to a portion whose cutting thickness is the longest, that is, a portion having a diameter thereof.

When a voltage of a certain value is applied between electrodes, i.e. between the cutting wire portions 1b and the workpiece W, and the distance between the electrodes reaches a value in a certain range, electrical discharges occur between the electrodes, and the workpiece W is melted by high heat caused by the electrical discharges. As a result, a plurality of plate-shaped members are cut out all at once. When the machining fluid is supplied to the gaps between the workpiece W and the cutting wire portions 1b during machining, cut debris generated between the workpiece W and the cutting wire portions 1b can be discharged to the outside of the gaps. The cut debris causes short circuits between the workpiece W and the cutting wire portions 1b, and so by supplying the machining fluid, the frequency of occurrence of short circuits can be reduced.

A machining fluid tank and a pump may be connected to the nozzles 7a and 7b. In addition, the machining fluid flow path restriction unit 400 in which the workpiece W is fixed may be set on an inner side of a work tank in which the machining fluid is stored, and electrical discharge machining may be performed with the workpiece W being submerged in the machining fluid.

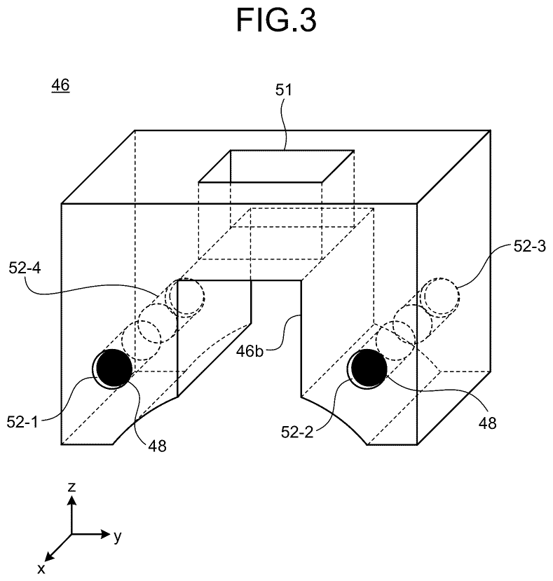

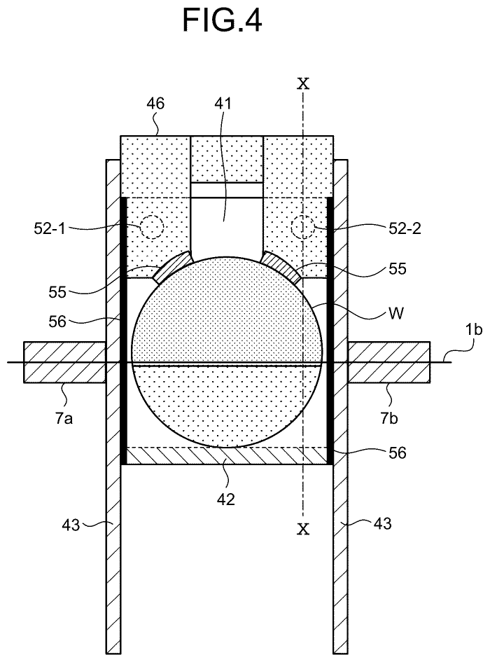

FIG. 3 is a perspective view illustrating a structure of the workpiece retainer 46 included in the wire electrical discharge machining apparatus 1000 according to the first embodiment. FIG. 4 is a cross-sectional view illustrating a structure of the machining fluid flow path restriction unit 400 included in the wire electrical discharge machining apparatus 1000 according to the first embodiment. FIG. 5 is another cross-sectional view illustrating the structure of the machining fluid flow path restriction unit 400 included in the wire electrical discharge machining apparatus 1000 according to the first embodiment. A left subfigure of FIG. 5 is a cross-sectional view taken along a line X-X of FIG. 4. A right subfigure of FIG. 5 is an enlarged view of an enlarged partial area of the left subfigure of FIG. 5. FIG. 4 illustrates a state in which cutting by the cutting wire portions 1b on the cylindrical workpiece W has been progressed to about one-half of the total cutting process.

As illustrated in FIGS. 4 and 5, the workpiece retainer 46 is inserted into a rectangular area surrounded by the pair of machining fluid flow straightening plates 41 and the pair of machining fluid escape prevention plates 43. The facing surface shape of the workpiece retainer 46 facing the rectangular area has a shape that allows the workpiece retainer 46 to slide while being in close contact with the pair of machining fluid flow straightening plates 41 and the pair of machining fluid escape prevention plates 43 thoroughly from the start of machining to the end of machining, so as to prevent the machining fluid from leaking from surfaces in contact with the plates 41 and 43.

As illustrated in FIG. 4, elastic bodies 56 made of rubber or the like are attached to portions of the workpiece retainer 46 in close contact with the machining fluid escape prevention plates 43, portions of the pair of machining fluid flow straightening plates 41 in close contact with the machining fluid escape prevention plates 43, and portions of the workpiece fixing plate 42 in close contact with the machining fluid escape prevention plates 43. When the machining fluid escape prevention plates 43 are installed before the start of machining, the elastic bodies 56 are set in a deformed state on the workpiece retainer 46, the machining fluid flow straightening plates 41, and the workpiece fixing plate 42, thereby making the elastic bodies 56 as a sealing material to seal gaps. As a result, the machining fluid escape prevention plates 43 are in close contact with the workpiece retainer 46, the machining fluid flow straightening plates 41, and the workpiece fixing plate 42, and the outflow of the machining fluid through gaps between the members constituting the machining fluid flow path restriction unit 400.

Consequently, the flow path of the machining fluid supplied to the inside of the machining fluid flow path restriction unit 400 is further limited to only machined grooves formed in the workpiece W, so that the flow rate of the machining fluid flowing into the machined grooves increases, the cutting wire portions 1b are cooled accordingly, cut debris is discharged from between the electrodes to the outside of the workpiece W accordingly, and more stable electrical discharge machining is performed. The elastic bodies 56 may be provided on the machining fluid escape prevention plate 43 side.

As illustrated in FIG. 3, the workpiece retainer 46 has a portion in contact with the workpiece W, the portion having been machined into a shape in conformity with the contour shape of the workpiece W. Many ingots used for semiconductor wafers have a cylindrical shape. For example, when the workpiece W is a cylindrical ingot having a diameter of six inches, the portion of the workpiece retainer 46 in contact with the workpiece W is machined into an arc shape having a diameter of six inches with its portion being cut out. A notch 46b is formed in the arc-shaped portion of the workpiece retainer 46. In the notch 46b, there is provided a machining fluid outlet 51 penetrating from the bottom surface to the top surface. The arc shape of the workpiece retainer 46 is selected according to the outer peripheral shape of the workpiece W so as to increase the area of contact with the workpiece W to firmly fix the workpiece W. The dimension of the workpiece retainer 46 in the x-axis direction is equal to or longer than the length of the workpiece W in the x-axis direction. The dimension of the workpiece retainer 46 in the y-axis direction is longer than the cutting width (diameter) of the workpiece W and is equal to the length of the machining fluid flow straightening plates 41.

As illustrated in FIGS. 3 to 5, holes 52-1 to 52-4 are formed in surfaces of the workpiece retainer 46 facing the machining fluid flow straightening plates 41. The holes 52-1 to 52-4 are bottomed cylindrical holes. A plunger 48 is provided in each of the holes 52-1 to 52-4. As illustrated in FIG. 5, each of the plungers 48 includes a pin 48a and a spring 48b. The pin 48a is biased outward by the spring 48b. On the other hand, recessed portions 41h into each of which the pin 48a of the plunger 48 is fitted are formed in the inner surfaces of the machining fluid flow straightening plates 41. The plungers 48 and the recessed portions 41h constitute a fixing mechanism for fixing the workpiece retainer 46 to the machining fluid flow straightening plates 41. When the workpiece retainer 46 is inserted from above into a space between the pair of machining fluid flow straightening plates 41 along the machining fluid flow straightening plates 41, the pins 48a biased outward by the springs 48b come into contact with the machining fluid flow straightening plates 41 and are pushed into the holes 52-1 to 52-4. As illustrated in FIG. 5, when the workpiece retainer 46 is moved to a position where the plungers 48 face the positions of the recessed portions 41h, parts of the pins 48a are fitted into the recessed portions 41h, thereby making the workpiece retainer 46 fixed to the pair of machining fluid flow straightening plates 41.

As illustrated in FIG. 4, elasto-plastic bodies 55 made of rubber, clay, or the like are attached to the arc portion of the workpiece retainer 46, the arc portion coming into contact with the workpiece W. When the workpiece retainer 46 is gradually pressed against the workpiece W while sliding along the machining fluid flow straightening plates 41, the elasto-plastic bodies 55 are deformed. As illustrated in the right subfigure of FIG. 5, the deformed elasto-plastic bodies 55 are pushed into the machined grooves Wz in multiple places formed in the workpiece W, thereby filling the machined grooves Wz, so that distal end portions of the thin plates of the workpiece W in the progression of cutting are fixed. As a result, the vibration of the thin plates due to the machining fluid flow or close contact between the thin plates is prevented, and a situation where the gap between the thin plates is narrowed or closed is averted. Since a change in the gap between the thin plates during machining is reduced, and the machined groove width between the adjacent thin plates is stabilized, the machining fluid supplied from the machining fluid ejection holes of the machining fluid escape prevention plates 43 to the inside of the machining fluid flow path restriction unit 400 is under static pressure inside the machining fluid flow path restriction unit 400, and is uniformly injected into the machined grooves Wz formed in the workpiece W. The machining fluid injected between the electrodes is moved through the machined grooves Wz generated by electrical discharge machining toward the machining fluid outlet 51 provided in the workpiece retainer 46, and is discharged from the machining fluid outlet 51 to the outside of the workpiece W. Consequently, accumulation of some cut debris between the thin plates is prevented, and secondary electrical discharges on the cut debris are reduced, so that more stable electrical discharge machining is performed.

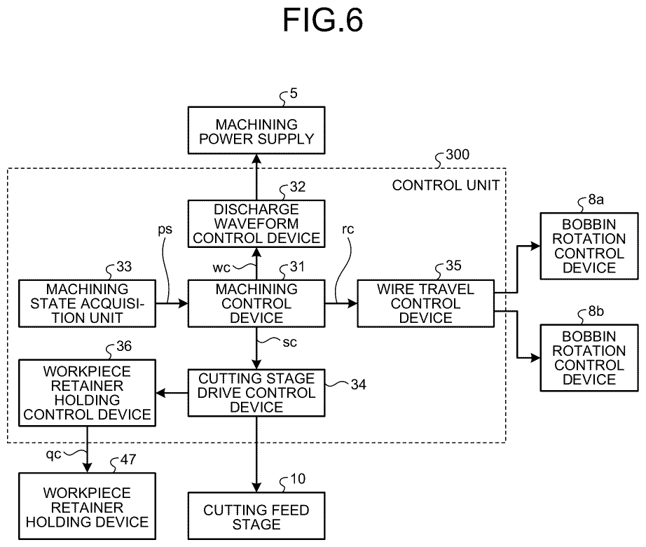

FIG. 6 is a block diagram illustrating a configuration example of the control unit 300 included in the wire electrical discharge machining apparatus 1000 according to the first embodiment. The control unit 300 includes a machining control device 31, a discharge waveform control device 32, a machining state acquisition unit 33, a cutting stage drive control device 34, a wire travel control device 35, and a workpiece retainer holding control device 36. The control unit 300 controls the wire electrical discharge machining apparatus 1000.

The machining state acquisition unit 33 acquires various kinds of machining state information ps including the position of the workpiece W in the z-axis direction from outputs of various types of sensors, and outputs the acquired machining state information ps to the machining control device 31. Based on the acquired machining state information ps, the machining control device 31 controls the discharge waveform control device 32, the cutting stage drive control device 34, and the wire travel control device 35. The discharge waveform control device 32 controls the machining power supply 5 based on a discharge waveform command wc inputted from the machining control device 31, to control a voltage waveform applied between the electrodes or a current waveform of an electric current flowing between the electrodes. The wire travel control device 35 controls the drive of the bobbin rotation control devices 8a and 8b based on a wire electrode travel command rc inputted from the machining control device 31, to control the travel of the wire electrode 1.

The cutting stage drive control device 34 drives the cutting feed stage 10 based on a stage command sc inputted from the machining control device 31, to control the relative position between the workpiece W and the cutting wire portions 1b. In addition, the cutting stage drive control device 34 also sends the stage command sc to the workpiece retainer holding control device 36 connected to the workpiece retainer holding device 47. The workpiece retainer holding control device 36 monitors the coordinate value of the cutting feed stage 10 in the z-axis direction, based on the stage command sc from the cutting stage drive control device 34, and retracts the holding mechanisms 47a of the workpiece retainer holding device 47 according to a retainer holding control command qc at the same time as when the cutting feed stage 10 reaches a first position preset, to release the held state of the workpiece retainer 46.

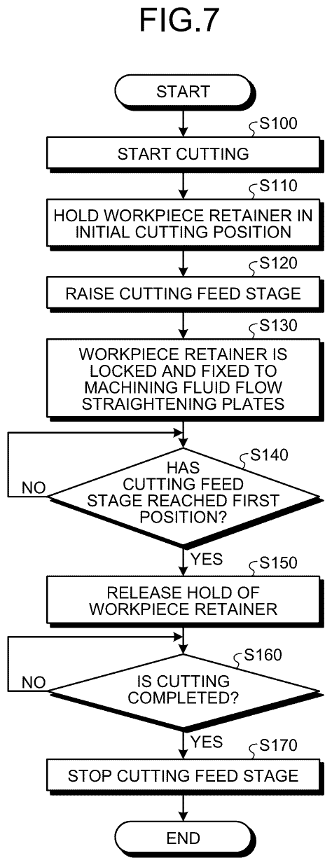

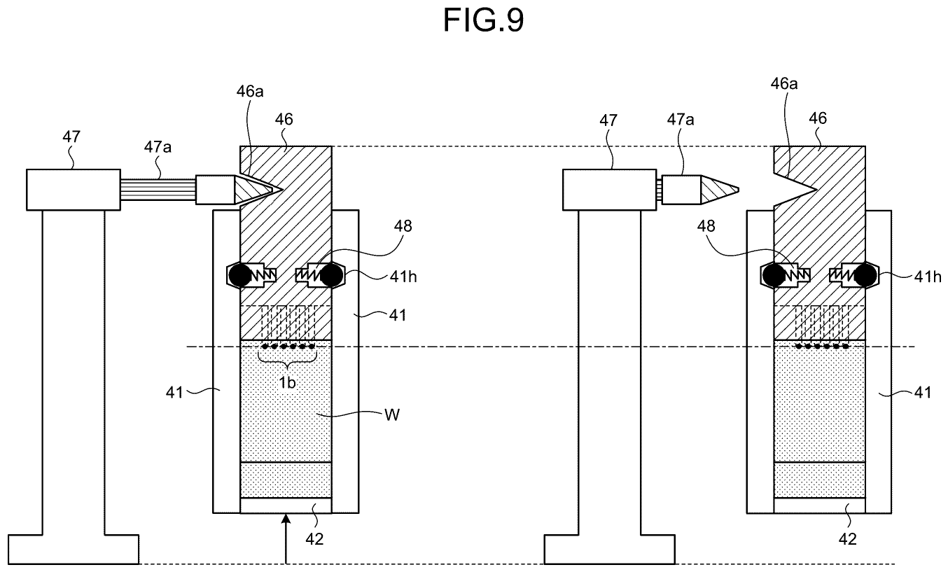

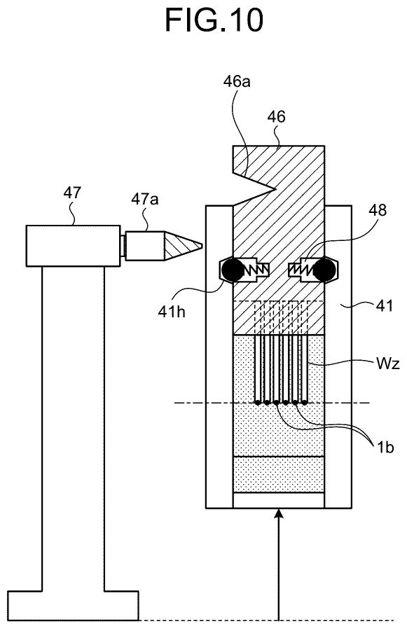

FIG. 7 is a flowchart illustrating the operation of the wire electrical discharge machining apparatus 1000 according to the first embodiment at the time of cutting. FIG. 8 is a cross-sectional view illustrating the movement of the wire electrical discharge machining apparatus 1000 according to the first embodiment in a first stage during the cutting process. FIG. 9 is a cross-sectional view illustrating the movement of the wire electrical discharge machining apparatus 1000 according to the first embodiment in a second stage during the cutting process. FIG. 10 is a cross-sectional view illustrating the movement of the wire electrical discharge machining apparatus 1000 according to the first embodiment in a third stage during the cutting process. The operation of the wire electrical discharge machining apparatus 1000 during the cutting process will be described with reference to FIGS. 7 to 10.

At the start of cutting, the cutting wire portions 1b are supported in a state of passing through the nozzle 7b and the through holes 43a of one machining fluid escape prevention plate 43 fixed on the nozzle 7b, passing directly above the workpiece W sandwiched between the two machining fluid flow straightening plates 41, and passing through the through holes 43a of the other machining fluid escape prevention plate 43 fixed on the nozzle 7a and the nozzle 7a. The cutting wire portions 1b travel in this state. In a situation where a work tank (not illustrated) filled with the machining fluid, electric power of the machining power supply 5 is supplied to the cutting wire portions 1b via the power feed terminal units 6a and 6b.

When the cutting is started, the control unit 300 causes the workpiece retainer holding device 47 to hold the workpiece retainer 46 in the initial cutting position (steps S100 and S110). The initial cutting position is a position upwardly away from the workpiece W and the cutting wire portions 1b. In the initial cutting position, a lower end portion of the workpiece retainer 46 is inserted in the rectangular area formed by the two machining fluid flow straightening plates 41 and the two machining fluid escape prevention plates 43. In the initial cutting position, the workpiece retainer 46 is not brought into contact with and fixed on the workpiece W in order to avoid interference of the workpiece retainer 46 with the cutting wire portions 1b. A left subfigure of FIG. 8 illustrates a state in which the workpiece retainer 46 is held in the initial cutting position. In the state in the left subfigure of FIG. 8, the workpiece retainer 46 is upwardly away from the workpiece W and the cutting wire portions 1b, and the plungers 48 are in positions away from the recessed portions 41h. In the state in the left subfigure of FIG. 8, the holding mechanisms 47a of the workpiece retainer holding device 47 are extended and fitted into the fitting portions 46a of the workpiece retainer 46. Thus, in the state in the left subfigure of FIG. 8, the workpiece retainer 46 is held in a position in the z-axis direction by the workpiece retainer holding device 47.

The flow of the machining fluid supplied from the nozzles 7a and 7b to the machining fluid flow path restriction unit 400 is restricted by the machining fluid flow straightening plates 41, and hits the workpiece W inside the machining fluid flow path restriction unit 400. In the machining fluid flow path restriction unit 400, the flow path of the machining fluid is limited to only the notch 46b of the workpiece retainer 46 and the machining fluid outlet 51, which are disposed in an upper part of the machining fluid flow path restriction unit 400. For this reason, the machining fluid bouncing back from the workpiece W or the like passes through the gap between the workpiece W and the workpiece retainer 46 and then is discharged through the notch 46b of the workpiece retainer 46 and the machining fluid outlet 51.

After the cutting is started, the control unit 300 lifts the cutting feed stage 10 up (step S120). Consequently, the workpiece fixing plate 42 and the pair of machining fluid flow straightening plates 41 on the cutting feed stage 10 rise relative to the pair of machining fluid escape prevention plates 43. A right subfigure of FIG. 8 illustrates a state in which the workpiece fixing plate 42 and the pair of machining fluid flow straightening plates 41 have slightly risen relative to the pair of machining fluid escape prevention plates 43 due to the rise of the cutting feed stage 10, with the workpiece retainer 46 being held in the initial cutting position. In the right subfigure of FIG. 8, cutting has been performed on an upper central portion of the workpiece W by the cutting wire portions 1b. In the right subfigure of FIG. 8, the plungers 48 are still in positions away from the recessed portions 41h, and the workpiece retainer 46 is held in the position in the z-axis direction by the workpiece retainer holding device 47.

When the cutting feed stage 10 is further lifted, as illustrated in a left subfigure of FIG. 9, the machining fluid flow straightening plates 41 rise relative to the workpiece retainer 46, and the plungers 48 are fitted into the recessed portions 41h. As a result, the workpiece retainer 46 is locked and fixed to the two machining fluid flow straightening plates 41 (step S130). In addition, as illustrated in the left subfigure of FIG. 9, cutting on the upper central portion of the workpiece W by the cutting wire portions 1b has further proceeded. In the state illustrated in the left subfigure of FIG. 9, the plungers 48 are fitted into the recessed portions 41h in a state where the workpiece retainer 46 has been brought into complete contact with the outer peripheral surface of the workpiece W, and machining has proceeded to a position where a part of the workpiece retainer 46 does not interfere with the cutting wire portions 1b.

The machining distance for the workpiece retainer 46 between the start of cutting and the actuation of the plunger mechanism 52 is designed based on the diameter of the workpiece W and the shape of the arc portion of the workpiece retainer 46. The workpiece retainer holding device 47 adjusts the initial cutting position that is the held position of the workpiece retainer 46 so that the plungers 48 are actuated with the workpiece retainer 46 being in complete contact with the outer peripheral surface of the workpiece W in a state where machining has proceeded to the position where a part of the workpiece retainer 46 does not interfere with the cutting wire portions 1b.

The first position, the positional relationship between the plungers 48 and the recessed portions 41h, etc. are set such that the cutting feed stage 10 reaches the first position preset, at the same time as the time when the plungers 48 are fitted into the recessed portions 41h. Therefore, at the point in time when the plungers 48 have been fitted into the recessed portions 41h, in the control unit 300, it is detected that the monitored coordinate value of the cutting feed stage 10 in the z-axis direction reaches the first position (step S140: Yes). In response to this detection, the control unit 300 outputs the retainer holding control command qc to the workpiece retainer holding device 47. As a result, as illustrated in a right subfigure of FIG. 9, the holding mechanisms 47a of the workpiece retainer holding device 47 are retracted, and the held state of the workpiece retainer 46 is released (step S150).

For the first position, a proper distance is set according to the cross-sectional diameter of the workpiece W, the maximum cutting length, or the like. For example, for the cylindrical workpiece W having a diameter of six inches, the first position may be set to a coordinate value at which machining has proceeded by about 20 mm to 25 mm from the cylindrical outer peripheral surface where the cutting is started. This is because even for the workpiece W of a large diameter exceeding six inches with a long cutting length, if the workpiece W is machined by about 20 mm in the Z direction from the start of machining, a machined thin plate portion is still small, and so the rigidity of the thin plates is kept high, the thin plate portions hardly vibrate, and the machining fluid can sufficiently flow into the machined grooves, thereby more stable electrical discharge machining being performed. In the above description, the first position is detected using the coordinate value of the cutting feed stage 10 in the z-axis direction, but the first position may be detected using the position of the workpiece W, the position of the workpiece fixing plate 42 on which the workpiece W is mounted, or the position of the pair of machining fluid flow straightening plates 41.

It is noted that the speed of travel of the workpiece retainer 46 in the z-axis direction performed by the cutting feed stage 10 is lower than the speed of movement of the holding mechanisms 47a of the workpiece retainer holding device 47. For this reason, thin plate machining by wire electrical discharge machining is continuously performed without even temporarily interrupting stage feeding by the cutting feed stage 10 and discharge pulse oscillations.

Thereafter, the held state of the workpiece retainer 46 provided by the workpiece retainer holding device 47 is released, and the workpiece retainer 46 is locked and fixed to the two machining fluid flow straightening plates 41. Consequently, as illustrated in FIG. 10, when the cutting feed stage 10 is further lifted, the workpiece retainer 46 rises together with the two machining fluid flow straightening plates 41 and the workpiece fixing plate 42 on which the workpiece W is placed, with the workpiece retainer 46 being locked and fixed to the two machining fluid flow straightening plates 41. By this elevation, the cutting on the workpiece W by the cutting wire portions 1b further proceeds, and a plurality of plate-shaped members are cut out from the workpiece W all at once.

When the coordinate value of the cutting feed stage 10 in the z-axis direction reaches a value indicating the end of the cutting process (step S160: Yes), the raising operation of the cutting feed stage 10 is stopped (step S170).

Note that the first position may be determined, as a result of the cutting, using the results of machine learning of the relationships between parameters during machining and a cutting depth at the point in time when the workpiece retainer 46 grips the cut-out thin plate portions of the workpiece W.

As described above, according to the first embodiment, cutting is started from a state in which the workpiece retainer 46 is held in the initial cutting position by the workpiece retainer holding device 47, and thereafter, when the coordinate value of the cutting feed stage 10 in the z-axis direction reaches the first position, the hold of the workpiece retainer 46 by the workpiece retainer holding device 47 is released, after which cutting is performed with the workpiece retainer 46 being locked and fixed to the two machining fluid flow straightening plates 41. That is, only by holding the workpiece retainer 46 in the initial cutting position without driving and moving the workpiece retainer 46 up and down during cutting, the workpiece W is held by the workpiece retainer 46. This eliminates the need for control to drive and move the workpiece retainer 46 together with the cutting feed stage 10, thereby allowing wire electrical discharge machining to be achieved under simpler control. Further, since the workpiece retainer 46 is held to be in contact with the workpiece W by locking and fixing the workpiece retainer 46 to the two machining fluid flow straightening plates 41, reinforcement of the stage mechanism becomes unnecessary.

Furthermore, since the machining fluid flow path restriction unit 400 configure to include the workpiece retainer 46 including the machining fluid outlet 51, the pair of machining fluid flow straightening plates 41, the pair of machining fluid escape prevention plates 43, and the workpiece fixing plate 42 is provided, the machining fluid is stably supplied between the electrodes, so that machining can be performed without local accumulation of cut debris and without interruption of wire electrical discharge machining. Consequently, secondary electrical discharges on the cut debris are reduced, local discharges are prevented, and the wire electrode is efficiently cooled, thereby making it possible to increase electrical discharge machining speed. Moreover, variations in the plate thickness of plate-shaped members cut out can be reduced, machining traces on the machined surfaces of the plate-shaped members can be reduced, and the probability of occurrence of disconnection of a wire electrode can be reduced.

### Second Embodiment

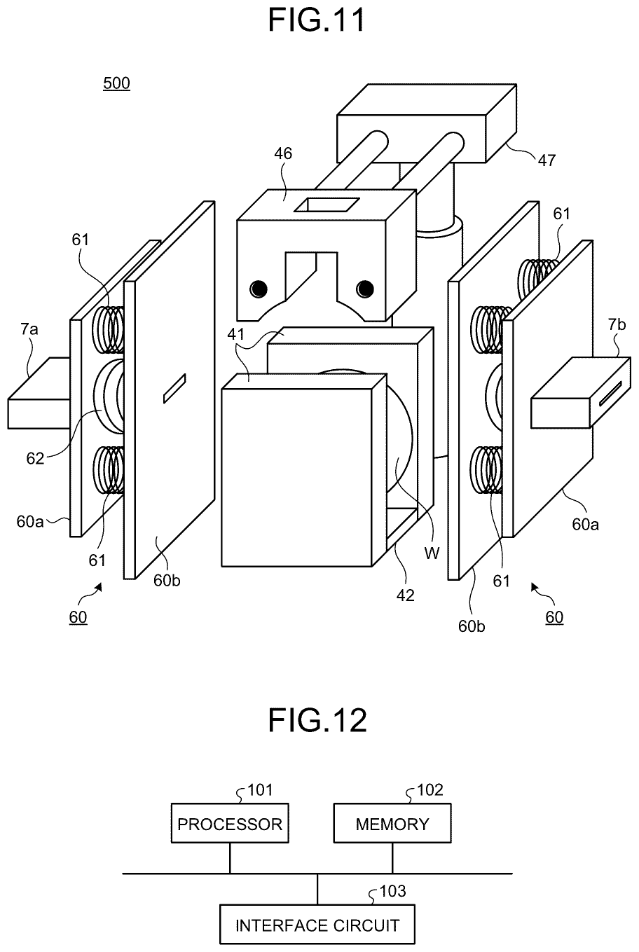

FIG. 11 is an exploded perspective view illustrating a configuration example of a machining fluid flow path restriction unit 500 of a wire electrical discharge machining apparatus according to a second embodiment. In the second embodiment, the machining fluid flow path restriction unit 400 of the first embodiment is replaced with the machining fluid flow path restriction unit 500. In the machining fluid flow path restriction unit 500, the machining fluid escape prevention plates 43 of the first embodiment are replaced with machining fluid escape prevention plates 60. The other components of the second embodiment are the same as those of the first embodiment and their redundant description is omitted.

One machining fluid escape prevention plate 60 is composed of two plates including a nozzle-side plate 60a connected to the nozzle 7a and a flow straightening plate-side plate 60b in contact with the machining fluid flow straightening plates 41. The other machining fluid escape prevention plate 60 is composed of two plates including a nozzle-side plate 60a connected to the nozzle 7b and a flow straightening plate-side plate 60b in contact with the machining fluid flow straightening plates 41. The facing surfaces of the nozzle-side plate 60a and the flow straightening plate-side plate 60b are connected by springs 61. Holes machined in the nozzle-side plate 60a and the flow straightening plate-side plate 60b are connected by a machining fluid feed pipe 62.

By using, for example, compression springs as the springs 61, even in a state where the nozzle-side plate 60a and the flow straightening plate-side plate 60b cannot be installed in parallel, the flow straightening plate-side plate 60b is pressed against and brought into close contact with the machining fluid flow straightening plates 41 by restoring forces generated by the springs 61 even in a bent state of the spring. The machining fluid feed pipe 62 is a flexible pipe such as a bellows shape flexible pipe, through the inside of which the machining fluid supplied from the nozzle 7a or 7b and the cutting wire portions 1b pass.

When the workpiece W is made of a semiconductor material, the angle of a cut surface with respect to the crystal direction of the semiconductor material affects the electrical properties of semiconductors manufactured from a wafer cut. Therefore, fine adjustment of a thin plate in a cutting direction is performed in a set-up process before cutting. Specifically, a rotating stage (not illustrated) for rotating the workpiece fixing plate 42 is provided between the workpiece fixing plate 42 and the cutting feed stage 10. The rotating stage adjusts the relative angle of a reference end surface of the workpiece W installed and fixed on the workpiece fixing plate 42 with respect to the cutting wire portions 1b. In most cases, the relative angle is adjusted by some degrees or less at most. However, the surfaces of the workpiece fixing plate 42 and the machining fluid flow straightening plates 41 in close contact with the flow straightening plate-side plates 60b rotate along the z-axis. Consequently, use of the machining fluid escape prevention plates 43 of the first embodiment leads to generation of some gap so that leakage of the machining fluid can be caused.

On the other hand, the machining fluid escape prevention plates 60 of the second embodiment have a two-plate structure in which the nozzle-side plates 60a connected to the nozzles 7a and 7b and the flow straightening plate-side plates 60b in contact with the machining fluid flow straightening plates 41 can move independently, so that the close contact state of the flow straightening plate-side plates 60b is maintained by the springs 61 even when the relative angle is adjusted.

As described above, according to the second embodiment, each machining fluid escape prevention plate 60 has the two-plate structure based on the nozzle-side plate 60a and the flow straightening plate-side plate 60b with the springs 61 being interposed therebetween. By this structure, the occurrence of leakage of the machining fluid is eliminated even when the angle of the cut surface is adjusted.

FIG. 12 is a block diagram illustrating an example of a hardware configuration of the control unit 300 included in the wire electrical discharge machining apparatus according to each of the first and second embodiments. The control unit 300 can be implemented by a processor 101, memory 102, and an interface circuit 103 illustrated in FIG. 12. An example of the processor 101 is a central processing unit (CPU, also called a central processor, a processing device, an arithmetic device, a microprocessor, a microcomputer, or a digital signal processor (DSP)), or a system large-scale integration (LSI). Examples of the memory 102 are random-access memory (RAM) and read-only memory (ROM).

The control unit 300 is implemented by the processor 101 reading out and executing a program stored in the memory 102, the program being configured to perform the operation of the control unit 300. The program can also be said to cause a computer to perform the procedure or method in the control unit 300. The memory 102 is also used as a temporary memory when the processor 101 performs various types of processing. The interface circuit 103 is an interface for connection with an apparatus external to the control unit 300. A part of the functions of the control unit 300 may be implemented by dedicated hardware and the other part thereof may be implemented by software or firmware.

The configurations described in the above embodiments illustrate just examples of the contents of the present disclosure, each of which can be combined with other publicly known techniques, and can be partly omitted and/or modified without departing from the scope of the present disclosure.

### REFERENCE SIGNS LIST

1 wire electrode; 1a parallel wire portion; 1b cutting wire portion; 2, 2-1 to 2-4 guide roller; 3, 3-1, 3-2 bobbin; 4a, 4b vibration-damping guide roller; 5 machining power supply; 6a, 6b feed terminal unit; 7a, 7b nozzle; 8a, 8b bobbin rotation control device; 9a, 9b traverse control device; 10 cutting feed stage; 31 machining control device; 32 discharge waveform control device; 33 machining state acquisition unit; 34 cutting stage drive control device; 35 wire travel control device; 36 workpiece retainer holding control device; 41 machining fluid flow straightening plate; 41h recessed portion; 42 workpiece fixing plate; 43, 60 machining fluid escape prevention plate; 43a through hole; 46 workpiece retainer; 46a fitting portion; 46b notch; 47 workpiece retainer holding device; 47a holding mechanism; 47b up and down movement mechanism; 48 plunger; 48a pin; 48b, 61 spring; 51 machining fluid outlet; 52-1 to 52-4 hole; 55 elasto-plastic body; 56 elastic body; 60a nozzle-side plate; 60b flow straightening plate-side plate; 62 machining fluid feed pipe; 100 machining mechanism; 101 processor; 102 memory; 103 interface circuit; 200 power feeding unit; 300 control unit; 400, 500 machining fluid flow path restriction unit; 1000 wire electrical discharge machining apparatus; W workpiece; Wz machined groove.

1. A wire electrical discharge machining apparatus, comprising:
a wire electrode including two or more cutting wire portions that are spaced apart from each other in parallel to each other and face a workpiece;
a power feeding unit to generate electrical discharges between the cutting wire portions and the workpiece;
a pair of nozzles including two or more ejection orifices through which the cutting wire portions are inserted, to supply a machining fluid to gaps between the cutting wire portions and the workpiece;
a workpiece fixing plate on which the workpiece is placed and fixed;
a pair of machining fluid flow straightening plates provided on both sides of the workpiece to sandwich the workpiece;
a pair of machining fluid escape prevention plates which are provided to sandwich the workpiece fixing plate and the pair of machining fluid flow straightening plates and connected to the ejection orifices of the pair of nozzles, and include two or more through holes through which the cutting wire portions are inserted;
a workpiece retainer inserted from above the workpiece and the cutting wire portions into a space surrounded by the pair of machining fluid flow straightening plates and the pair of machining fluid escape prevention plates, to hold the workpiece being separated during cutting;
a cutting feed stage to move the workpiece fixing plate and the pair of machining fluid flow straightening plates up and down with respect to the pair of machining fluid escape prevention plates and the cutting wire portions;
a holding device to hold the workpiece retainer in an initial cutting position upwardly away from the cutting wire portions; and
a control unit to control the holding device so that the cutting feed stage is driven when cutting is started to move upward the workpiece fixing plate on which the workpiece is placed and fixed and the pair of machining fluid flow straightening plates with respect to the pair of machining fluid escape prevention plates so as to bring the workpiece fixing plate and the pair of machining fluid flow straightening plates closer to the cutting wire portions, and the workpiece retainer is held in the initial cutting position until the workpiece reaches a first position by the upward movement, and to control the holding device to release the hold of the workpiece retainer after the workpiece reaches the first position.

2. The wire electrical discharge machining apparatus according to claim 1, comprising
a fixing mechanism to lock and fix the workpiece retainer to the pair of machining fluid flow straightening plates when the workpiece reaches the first position, wherein
after the workpiece reaches the first position, the control unit controls so that the cutting feed stage is driven with the workpiece retainer being locked and fixed to the pair of machining fluid flow straightening plates by the fixing mechanism, to move the workpiece fixing plate on which the workpiece is mounted and the pair of machining fluid flow straightening plates upward with respect to the pair of machining fluid escape prevention plates until completion of the cutting, so as to cut the workpiece.

3. The wire electrical discharge machining apparatus according to claim 2, wherein
the workpiece retainer includes a plurality of bottomed holes, and
the fixing mechanism includes a plurality of plungers with springs which are provided in the bottomed holes of the workpiece retainer, respectively, and a plurality of recessed portions provided in the pair of flow straightening plates, into which the plurality of plungers with springs are fitted.

4. The wire electrical discharge machining apparatus according to claim 1, wherein the workpiece retainer includes a machining fluid outlet penetrating from a bottom surface thereof to a top surface thereof.

5. The wire electrical discharge machining apparatus according to claim 1, wherein elastic bodies are provided to surfaces of the workpiece retainer in contact with the machining fluid escape prevention plates, surfaces of the pair of machining fluid flow straightening plates in contact with the machining fluid escape prevention plates, and portions of the workpiece fixing plate in contact with the machining fluid escape prevention plates.

6. The wire electrical discharge machining apparatus according to claim 1, to wherein a surface of the workpiece retainer in contact with the workpiece has a shape in conformity with an outer peripheral shape of the workpiece, and elasto-plastic bodies are provided to the surface of the workpiece retainer in contact with the workpiece.

7. The wire electrical discharge machining apparatus according to claim 1, to wherein each of the pair of machining fluid escape prevention plates is composed of a pair of side plates between which a spring is sandwiched.

8. A wire electrical discharge machining apparatus, comprising:
a first member across which two or more cutting wire portions are extended;
a second member to which a workpiece is fixed, the second member forming, together with the first member, a space into which a machining fluid flows from the first member to the workpiece;
a third member held in an initial cutting position upwardly away from the cutting wire portions, and inserted into the space to hold, from above, the workpiece being separated during cutting;
a fixing mechanism to lock and fix the third member to the second member; and
a control unit to control so that the second member on which the workpiece is mounted is moved upward relative to the first member when cutting is started to bring the second member closer to the third member and the cutting wire portions, the third member is held in the initial cutting position until the workpiece reaches a first position, the hold is released when the workpiece reaches the first position, and after the workpiece reaches the first position, the second member on which the workpiece is mounted is moved upward relative to the first member until completion of the cutting, with the third member being locked and fixed to the second member by the fixing mechanism, so as to cut the workpiece.

9. A wire electrical discharge machining method, comprising:
a first member across which a plurality of cutting wire portions is extended;
a second member to which a workpiece is fixed, the second member forming, together with the first member, a space into which a machining fluid flows from the first member to the workpiece; and
a third member held in an initial cutting position upwardly away from the cutting wire portions, to hold, from above, the workpiece inserted into the space and separated during cutting,
the method comprising:
moving upward the second member on which the workpiece is mounted relative to the first member when cutting is started, to bring the second member closer to the third member and the plurality of cutting wire portions;
holding the third member in the initial cutting position until the workpiece reaches a first position; and
after the workpiece reaches the first position, releasing the hold and moving the second member on which the workpiece is mounted upward relative to the first member until completion of the cutting, with the third member being fixed to the second member, so as to cut the workpiece.
